(19) United States
(12) Patent Application Publication
(10) Pub. No.: US 2005/0284802 A1
(43) Pub. Date: Dec. 29, 2005

(54) Filtering device with integral filter status indicator

(76) Inventors: George A. Jankuski, Glenbeulah, WI (US); Timothy S. Thiel, Howards Grove, WI (US)

Correspondence Address: QUARLES & BRADY LLP, 411 E. WISCONSIN AVENUE, SUITE 2040, MILWAUKEE, WI, 53202-4497, US

(21) Appl. No.: 10/874,824

(22) Filed: Jun. 23, 2004

(51) Int. Cl. B01D 33/00

(52) U.S. Cl. 210/106; 210/149; 210/443; 210/354; 210/744

(57) ABSTRACT

A filtering apparatus and method of operating a filtering device are disclosed. The apparatus includes a housing having an inlet and an outlet and at least first and second cavities that are coupled to the inlet and outlet, respectively, where an input fluid within the first cavity has an input pressure and an output fluid within the second cavity has an output pressure. The apparatus additionally includes a filter supported within the housing, where at least a portion of the filter extends along an axis within the housing, and the filter at least partly separates the cavities from one another. The apparatus further includes a device capable of determining whether the input pressure exceeds the output pressure by an amount and providing an indication thereof, the device being supported by the housing and extending into the housing along the axis and at least partly into a void within the filter.

### FIELD OF THE INVENTION

The present invention relates to filtering devices that filter oil or other fluids, and more particularly relates to such filtering devices that are used in internal combustion engines.

### BACKGROUND OF THE INVENTION

Filtering devices are used in a variety of capacities in internal combustion engines such as those employed in vehicles, generators, and other applications. Because filters typically deteriorate over time, due to the clogging of the filters with dirt and other materials as fluid passes through the filters, the filters must be replaced with a relatively high frequency. This is true both with respect to filters for oil, hydraulic fluid, water, and other liquids, as well as for air filters and other types of filters.

As a result, filtering devices commonly are designed to allow for easy replacement of the filters within such filtering devices or, in other circumstances, to allow for easy replacement of the entire filtering devices. With respect to the latter class of filtering devices in particular, it is typically desirable for the filtering devices to be not only easily removable but also compact. By making the filtering device compact, it is easier and more convenient for technicians and consumers to obtain and install replacement filtering devices, and also easier to design the engines on which the filtering devices are to be mounted to allow for easy coupling of the filtering devices to the engines.

Because of the relatively rapid deterioration of the filters within filtering devices, and because it is desirable for the best performance of the engines with which the filtering devices are employed that the filtering devices operate properly, it is desirable that technicians and/or consumers be able to readily determine whether the filtering devices are in fact operating properly. In particular, it is desirable that technicians and/or consumers be able to readily determine whether the filters within the filtering devices have become excessively clogged. Because filtering devices of this type are designed to be entirely replaced, the filters within those filtering devices often are not readily accessible for visual inspection and, in any case, visual inspection is often not a reliable or easy way of determining whether filters are excessively clogged.

In relation to this objective, some engines (particularly engines intended to be fixed in place rather than on mobile vehicles) are equipped with a filter status indicator that employs a pressure-sensitive device that is in communication with the fluid flowing into and out of the filtering device. The pressure-sensitive device is capable of detecting whether a pressure differential between the inflowing and outflowing fluid has become excessive, which is an indication of whether the pressure differential across the filter within the filtering device has become excessive. This in turn can serve as an indication of whether the filter has become excessively clogged since, when the filter becomes clogged, less oil passes through the filter and consequently the oil pressure on the filtered side of the filter is lessened and/or the oil pressure on the unfiltered side increases.

In many conventional embodiments, the filter status indicator not only includes a pressure-sensitive device but further includes a moving portion such as a shaft that changes in position depending upon the pressure differential and, based upon its position, provides a visible indication of the pressure differential across the filter within the filtering device. Exemplary conventional filter status indicators that are used in conjunction with oil filtering devices are shown in, for example, U.S. Pat. Nos. 3,150,633; 4,139,466; 4,654,140; and 4,783,256, which respectively issued to Holl, Rosaen, Chen, and Cooper et al., respectively, on Sep. 29, 1964, Feb. 13, 1979, Mar. 31, 1987, and Nov. 8, 1988, respectively, each of which is hereby incorporated by reference herein.

Although a variety of conventional engines have such filter status indicators for determining the status of filters within removable/add-on filtering devices, such conventional engine arrangements have several disadvantages. To begin, the filter status indicators should be positioned close to the locations at which the filtering devices are coupled to the engines, both in order to improve the accuracy of the pressure sensing performed by the filter status indicators and to make it evident that the filter status indicators actually pertain to the filtering devices. However, positioning of the filter status indicators close to the filtering devices can be problematic because the filter status indicators tend to require a significant amount of premium space within the engines.

Further, in order to make it possible for the filter status indicators to be positioned close to the filtering devices, as well as to facilitate the installation and removal of the filtering devices in relation to the filter status indicators and the rest of the engines, the filter status indicators often must take on complicated structural configurations so that the filter status indicators do not obstruct or excessively restrict positioning, installation and removal of the filtering devices. Filter status indicators having these complicated structural configurations can be both difficult to design and expensive to manufacture.

Therefore it would be advantageous if a new engine arrangement employing a filtering device and a filter status indicator could be developed, where the filter status indicator did not take up as much space within the engine and had a less complicated structural form than in conventional arrangements. Additionally, it would be advantageous if the new filtering device did not obstruct or inhibit the assembly and removal of filtering devices with respect to an engine. Further, it would be advantageous if the filtering device still was capable of accurately determining and providing a clear indication of filter status and, in particular, an indication when a filter has become excessively clogged.

### SUMMARY OF THE INVENTION

The present inventors have recognized that filter status indicators could be advantageously positioned on the replaceable filtering devices themselves rather than separate from those filtering devices on the engines on which the filtering devices are mounted. Additionally, the present inventors have recognized that cylindrical filtering devices employing tubular filters have relatively large cavities within the center of the filters that, while intended to be filled with filtered fluid, could also be at least partly filled with other materials and/or devices.

In particular, the present inventors have recognized that a filter stats indicator having a pressure differential sensing device could be partly, largely, or even entirely positioned within the cylindrical cavity of a cylindrical filtering device. By mounting the pressure differential sensing device within the cylindrical cavity, the filtering device including the pressure differential sensing device does not need to be larger (or at least does not need to be much larger) than a filtering device without the pressure differential sensing device, nor does the general outside shape of the filtering device need to be substantially modified in order to accommodate the inclusion of the pressure differential sensing device.

In particular, the present invention relates to a filtering apparatus. The filtering apparatus includes a first cylindrical housing having first and second ends, and further including a fluid inlet and a fluid outlet, and additionally a tubular filter supported within the first cylindrical housing and having outer and inner cylindrical surfaces. An outer region that receives input fluid from the inlet exists in between the outer cylindrical surface and the first cylindrical housing, an inner region that provides filtered fluid to the outlet exists within the inner cylindrical surface, the input fluid becomes the filtered fluid upon passing through the tubular filter, and the respective input and filtered fluids within the respective outer and inner regions experience outer and inner fluid pressures, respectively. The filtering apparatus further includes a device extending from the second end of the first cylindrical housing inward into the first cylindrical housing and at least partly into the inner region, where the device includes a second cylindrical housing, a biasing member, and an additional housing portion that is movable in relation to the second cylindrical housing. Respective internal surfaces of the additional housing portion and the second cylindrical housing at least partly define a cavity. A channel links the cavity to the inner region so that at least some of the filtered fluid enters the cavity and so that the internal surface of the additional housing portion experiences a first force due to the inner fluid pressure, an external surface of the additional housing portion is in fluid communication with the outer region so that the external surface experiences a second force due to the outer fluid pressure, and the biasing member applies a third force upon the additional housing portion tending to supplement the first force. The additional housing portion at least one of includes and is coupled to a protrusion that moves from a retracted position to an extended position in which the protrusion extends outward from the second end when the second force exceeds a threshold.

Additionally, the present invention relates to a removable filtering apparatus for implementation in an engine, where the apparatus includes a housing and a filter supported within the housing. The housing has an inlet and an outlet and at least first and second cavities that are coupled to the inlet and the outlet, respectively, where an input fluid within the first cavity has an input fluid pressure and an output fluid within the second cavity has an output fluid pressure. At least a portion of the filter extends along an axis within the housing, and the filter at least partly separates the first and second cavities from one another. The filtering apparatus further includes a device capable of determining whether the input fluid pressure exceeds the output fluid pressure by a predetermined amount and providing an indication thereof, where the device is supported by the housing and extends into the housing along the axis and at least partly into a void within the filter.

Further, the present invention relates to a method of operating a filtering device to provide an indication of when a filter within the filter device is excessively dirty. The method includes providing a housing within which is supported a filter, where at least a portion of the filter extends along an axis within the housing, where the filter at least partly separates first and second cavities within the housing containing input fluid and filtered fluid, respectively, and where an input fluid pressure is experienced within the first cavity and a filtered fluid pressure is experienced within the second cavity. The method further includes providing a component capable of determining whether the input fluid pressure exceeds the filtered fluid pressure by a predetermined amount, where the component is supported by the housing and extends into the housing along the axis and at least partly alongside the filter. The method additionally includes operating the component to perform filtering, and experiencing a change in at least one of the input fluid pressure and the filtered fluid pressure that results in the input fluid pressure exceeding the filtered fluid pressure by at least the predetermined amount. The method also includes providing an indication at the component that the input fluid pressure exceeds the filtered fluid pressure by at least the predetermined amount.

### BRIEF DESCRIPTION OF THE DRAWINGS

FIG. 1 is a cross-sectional view of an exemplary filtering device in accordance with one embodiment of the present invention.

### DETAILED DESCRIPTION OF THE PREFERRED EMBODIMENT

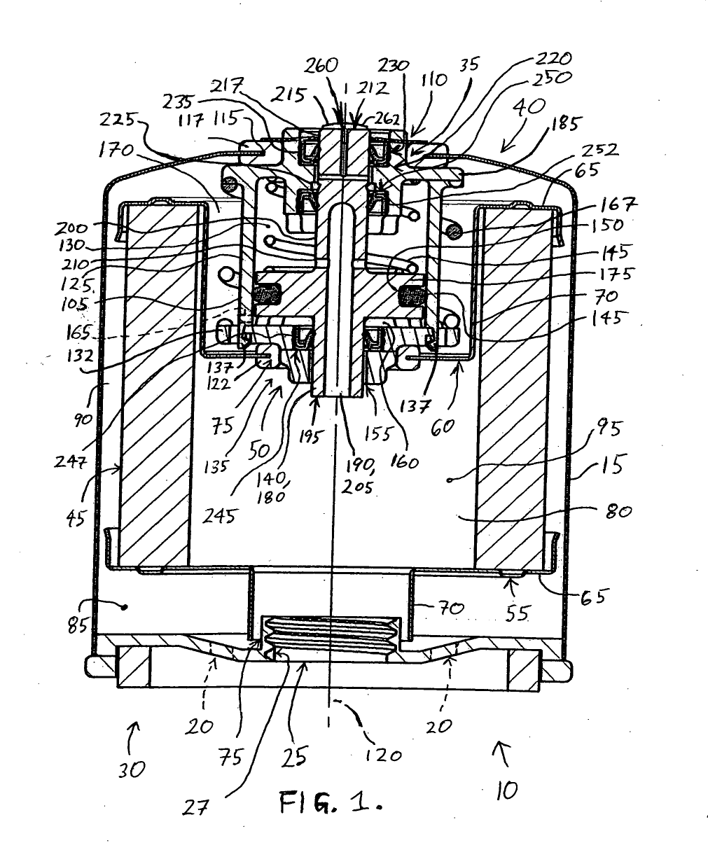

Referring to FIG. 1, an exemplary filtering device 10 in accordance with one embodiment of the present invention is shown. The filtering device 10 in the present embodiment is intended to be used to filter oil or other lubricant, although in other embodiments the filtering device (or variations thereof) can be used to filter water or other fluids as well. As shown, the filtering device 10 includes a cylindrical housing or canister 15 with one or more input ports 20 and an output port 25 at a first end 30, and a central orifice 35 at a second end 40. Supported within the canister 15 is a tubular oil filter 45. Further, in accordance with one embodiment of the present invention, a filter status indicator 50 is additionally supported by the canister 15. As described in further detail below, the filter status indicator 50 operates to determine whether the oil filter 45 is excessively dirty or clogged and is capable of providing an indication thereof.

More particularly, as shown, within the canister 15 are first and second support structures 55 and 60, each of which generally is of the shape of a top-hat having a respective rim portion and a respective cylindrical portion 70 including a hole 75 at its center (as shown in FIG. 1, the top-hat-shaped support structures are both inverted). The oil filter 45 is supported between the rim portions 65 of the two support structures 55, 60, which interface first and second annular ends of the oil filter 45. The cylindrical portion 70 of the first support structure 55 extends away from the oil filter 45 to interface the first end 30 of the filtering device 10, while the cylindrical portion of the second support structure 60 extends partly into a cylindrical cavity 80 defined by the inner cylindrical surface of the tubular oil filter 45 or, in some embodiments, defined by an additional cylindrical perforated wall surface (not shown) positioned along the inner cylindrical surface of the filter.

The filtering device 10 is capable of being easily installed and removed with respect to an engine (not shown), and in the present embodiment is installed by rotating the filtering device so that a threaded female interface 27 at the first end 30 engages a complementary male interface (not shown) of the engine. In other embodiments, the filtering device 10 can be coupled/decoupled with respect to the engine by way of other structures and techniques known to those of ordinary skill in the art. The filtering device 10 generally operates as follows to clean/filter oil as it is provided to the filtering device (typically from the crankcase of an engine, not shown). To begin, unfiltered (or prefiltered) oil 85, which typically is dirty and in need of filtering, enters the generally cylindrical filtering device 10 by way of the input ports 20 at the first end 30 of the filtering device. The unfiltered oil 85, upon entering the input ports 20, proceeds to enter a cavity 90 that concentrically surrounds the tubular oil filter 45 that is supported within the filtering device 10.

During normal operation, the unfiltered oil 85 then flows from the cavity 90 through the oil filter 45 into the cylindrical cavity 80 within the oil filter. Due to the filtering performed by the oil filter 45 as the oil passes through it, the oil within the cylindrical cavity 80 is filtered (or “clean”) oil 95. From the cylindrical cavity 80, the filtered oil 95 is able to exit the oil filter 45 by way of the output port 25.

Additionally as shown, although the input port 20 and the output port 25 are both located at the first end 30 of the oil filter device 10, the two ports are separated from one another by the rim portion 65 and cylindrical portion 70 of the first support structure 55. The output port 25 is formed at least in part by the hole 75 of the first support structure 55, and the input ports 20 are located concentrically around the cylindrical portion 70 and lead to an annular region 100 existing between the canister 15 itself and the cylindrical portion 70 and rim portion 65 of the first support structure 55. The annular region 100 generally is an extension of the cavity 90 that is concentric about the cylindrical portion 70 rather than around the oil filter 45.

Further with respect to the filter status indicator 50, that component generally takes the form of an additional cylindrical canister 105. A first end 110 of the filter status indicator 50 is supported by an inner edge 115 of the central orifice 35 at the second end 40 of the oil filter device 10 by way of a first grommet seal 117. From the inner edge 115 and first grommet seal 117, the filter status indicator 50 extends further inward into the filtering device 10 and in particular extends into the cylindrical portion 70 of the second support structure 60 up to the hole 75 at the support structure's center at the end of the cylindrical portion (e.g., at the bottom of the support structure as shown in FIG. 1). A second end 135 of the filter status indicator 50 is supported by the cylindrical portion 70 of the second support structure 60 within the hole 75 by way of a second grommet seal 122. The filter status indicator 50 generally extends inward along a central axis 120 of the filtering device 10.

The filter status indicator 50 includes a cylindrical housing portion 125 within which is an inner chamber 130 and an end plate portion 132 that snaps/clips onto the cylindrical housing portion 125 at the second end 135 by way of several clips 137 on the housing portion. Additionally, extending axially through the filter status indicator 50 from the first end 110 through the housing portion 125 and through a central opening 155 within the end plate portion 132 at the second end 135, is a central piston 140 that is capable of moving axially along the central axis 120 in relation to the housing and end plate portions 125, 132. The central piston 140 includes a flange portion 175 that extends radially outward from a central shaft portion 180 of the piston toward housing portion 125. An o-ring seal 145 is positioned within a groove 150 along the circumference of the flange portion 175 and is wedged between the flange portion and the housing portion 125, thereby sealing the inner chamber 130 from an annular region 160 existing between the flange portion and the end plate portion 132. The central piston 140 is biased toward the cylindrical cavity 80 of the filtering device 10 (e.g., biased downward as shown in FIG. 1) by an internal spring 145 positioned within the housing portion 125 as well as by any pressure provided by any filtered oil 95 that is contained within the inner chamber 130 as discussed further below.

The o-ring seal 145 is preferably a low-drag seal to avoid creating excessive drag upon movement of the piston 140. Nevertheless, the internal spring 145 in part is preferably designed to accommodate any resistance created by the o-ring seal 145. In one embodiment, the spring provides a force of 7 lbs. In alternate embodiments, the other types of seals can be used in place of the o-ring seal 145 or other structures can be employed to seal the inner chamber 130 from the annular region 160; for example, a flexible diaphragm (not shown) can be coupled between the flange portion 132 and the housing portion 125.

As shown, an additional region 170 that is in fluid communication with the cavity 90 exists in between the cylindrical portion 70 of the support structure 60 and the filter status indicator 50. Further, the annular region 160 is in fluid communication with the additional region 170 by way of a plurality of channels 165 extending through the housing portion 125. Consequently, the annular region 160 is filled with some of the unfiltered oil 85. At the same time, the end plate portion 132 in combination with the second grommet seal 122 seals off the additional region 170 from the cylindrical cavity 80, which would otherwise be in fluid communication via the hole 75 in the cylindrical portion 70 of the second support structure 60. The end plate portion 132 in particular is held tight against the second grommet seal 122 by way of an additional spring 167 extending between a lip 85 of the housing portion 125 proximate the first end 110 and the end plate itself at the second end 135. Use of the additional spring 167, which tends to press the end plate portion 132 away from the housing portion 125 despite the clips 137 linking those two portions, allows the sealing of the end plate portion 132 in relation to the second grommet seal 122 to be tight even though there may be slight variations in the tolerances/stack height of components within the filtering device, e.g., variation in the distance between the first and second grommet seals 117 and 122, respectively.

Further, first and second lip seals 245 and 250 are positioned within respective first and second recesses 247 and 252 of the end plate portion 132 and the housing portion 125 to interface the central shaft portion 180 of the piston 140. By virtue of these respective lip seals 245 and 250, unfiltered oil 85 is prevented from flowing from the annular region 160 along the shaft portion 180 and into the cylindrical cavity 80, and also filtered oil 95 is prevented from flowing up and along the shaft portion from the inner chamber 130 and out of the filtering device 10.

Further as shown, the piston 140 includes a channel 190 extending from a first end surface 195 of the piston that is adjacent the cylindrical cavity 80 to a side surface 200 of the piston that is adjacent the inner chamber 130. In the embodiment shown, the channel 190 actually includes a first portion 205 extending axially along the central axis 120 and a second portion 210 that crosses the first portion and extends radially outward to the side surface 200 (thus, the channel 190 can be formed simply by drilling two holes), although in alternate embodiments the exact shape of the channel could vary from that shown. The channel 190 allows the filtered oil 95 to flow freely from the cylindrical cavity 80 to the inner chamber 130 so that the filtered oil pressures within the cavity and chamber are identical (or at least approximately equal).

Although the unfiltered oil 85 is sealed off from the inner chamber 130 by way of the flange portion 175 and the o-ring seal 145, the unfiltered oil nevertheless is communicated within the additional region 170 and into the annular region 160, and consequently provides pressure upon the flange portion and the seal. If the force applied to the flange portion 175 and o-ring seal 145 by the unfiltered oil 85 (plus a small amount of force applied by the filtered oil 95 of the cylindrical cavity 80 to the first end surface 195 of the piston 140) exceeds the force applied to the flange portion and seal by the filtered oil 95 within the inner chamber 130 (plus whatever drag force is imparted by the o-ring seal interfacing the housing portion 125) by a specific amount determined by the force applied by the spring 145, then the piston 140 is forced away from the cylindrical cavity 80 (in the embodiment shown, forced upwards). Such can occur when the oil filter 45 is excessively clogged such that it does not allow oil to sufficiently easily pass through it.

As the piston 140 is forced upwards, a top 215 of the piston is exposed as an indication that the oil filter 45 is excessively dirty/clogged, such that the oil filtering device 10 (or at least the filter itself) should be changed. In some embodiments, a color of a second end surface 212 of the top 215 of the piston matches that of the surrounding portions of the top of the filtering device 10 (e.g., black) while a side surface 217 of the top has a different color (e.g., red) such that exposure of the top is readily apparent.

Further as shown, the filter status indicator 50 includes a latching mechanism 220 that locks when the piston 140 is urged sufficiently upward and the top 215 becomes sufficiently exposed, in order to lock the piston in place so that it cannot return to its retracted position (e.g., move back toward the cavity 80) even though the pressure differential between the unfiltered oil 85 and filtered oil 95 might later fall to an acceptable level. In the present embodiment, the latching mechanism 220 is formed by the interaction of a recess or indentation 225 on the shaft portion 180 of the piston 140 proximate the piston's top 215 and a third lip seal 230 positioned within an additional recess 235 within the housing portion 125 proximate the first end 110, through which the piston passes. The third seal 230 is oriented opposite the orientation of the second seal 250, such that, as the piston 140 moves sufficiently upward, the lip seal 230 juts into the recess 235 and then prevents the recess from returning back below the seal. In alternate embodiments, other latching mechanisms than that shown can be employed.

Additionally, in a preferred embodiment, a temperature sensitive material 255 is positioned along the shaft portion 180 of the piston 140, in this embodiment in between the second and third lip seals 250 and 230. The temperature sensitive material 255 expands and contracts with different temperatures such that, if the temperature becomes too cold (e.g., below 180° F.), the temperature sensitive material expands to prevent movement of the piston 140, and if the temperature becomes sufficiently warm (e.g., 180° F. or above), the material contracts and allows piston movement. This is advantageous since, in certain circumstances in which the temperature is low (for example, due to a cold starting temperature of the engine), the pressure differential between the filtered and unfiltered oil can be large even though the filter 45 does not need to be changed. A variety of different temperature sensitive materials can be employed depending upon the embodiment such as, for example, wax. In the embodiment shown, the temperature sensitive material can be inserted into position between the second and third seals 250, 230 via a channel 260 through the piston 140 extending from the second end surface 212 to a portion of the side surface 217 located between those two lip seals. Once the material is added, a cap 262 is used to close off the channel 260.

While the foregoing specification illustrates and describes the preferred embodiments of this invention, it is to be understood that the invention is not limited to the precise construction herein disclosed. The invention can be embodied in other specific forms without departing from the spirit or essential attributes. For example, although the invention as discussed above pertains to oil filters, the invention also could be employed in relation to other filtering devices for filtering other fluids such as hydraulic fluids, transmission fluids, water, etc. as well as air.

Also, other configurations performing the same overall functions could also be employed. For example, in one alternate embodiment, a piston could be mounted for movement that was generally perpendicular to the central axis 120 within an oil filter status indicator that was largely positioned within the cylindrical cavity 80 but not entirely, such that the piston could extend along the second end 40 (e.g., perpendicular to the central axis) and be extended/retracted out of and into an orifice within the side (cylindrical) outer surface of the oil filter device 10. Also, in certain embodiments, a bypass or pressure relief valve can be included within the filtering device to relieve/prevent excessive build-ups of pressure within the device.

Accordingly, reference should be made to the following claims, rather than to the foregoing specification, as indicating the scope of the invention.

1. A filtering apparatus comprising:
a first cylindrical housing having first and second ends, and further including a fluid inlet and a fluid outlet;
a tubular filter supported within the first cylindrical housing and having outer and inner cylindrical surfaces,
wherein an outer region that receives input fluid from the inlet exists in between the outer cylindrical surface and the first cylindrical housing, wherein an inner region that provides filtered fluid to the outlet exists within the inner cylindrical surface, wherein the input fluid becomes the filtered fluid upon passing through the tubular filter, and wherein the respective input and filtered fluids within the respective outer and inner regions experience outer and inner fluid pressures, respectively; and
a device extending from the second end of the first cylindrical housing inward into the first cylindrical housing and at least partly into the inner region, wherein the device includes a second cylindrical housing, a biasing member, and an additional housing portion that is movable in relation to the second cylindrical housing,
wherein respective internal surfaces of the additional housing portion and the second cylindrical housing at least partly define a cavity, wherein a channel links the cavity to the inner region so that at least some of the filtered fluid enters the cavity and so that the internal surface of the additional housing portion experiences a first force due to the inner fluid pressure, wherein an external surface of the additional housing portion is in fluid communication with the outer region so that the external surface experiences a second force due to the outer fluid pressure, and wherein the biasing member applies a third force upon the additional housing portion tending to supplement the first force, and
wherein the additional housing portion at least one of includes and is coupled to a protrusion that moves from a retracted position to an extended position in which the protrusion extends outward from the second end when the second force exceeds a threshold.

2. The filtering apparatus of claim 1, wherein each of the first and second cylindrical housings is centered upon a central axis.

3. The filtering apparatus of claim 1, wherein the additional housing portion at least one of is coupled to the second cylindrical housing by way of a flexible diaphragm and includes a seal that interfaces the second cylindrical housing and seals off the cavity from the external surface.

4. The filtering apparatus of claim 1, wherein the outlet is a primary orifice at a center of the first end.

5. The filtering apparatus of claim 4, wherein the inlet includes at least one secondary orifice that is positioned proximate to the first end and radially outward away from a central axis and from the first orifice.

6. The filtering apparatus of claim 5, wherein coupled to and extending into the first cylindrical housing is a first support structure having a rim portion and a cylindrical portion, wherein the rim portion supports the tubular filter.

7. The filtering apparatus of claim 1, further including a locking component that prevents the protrusion from moving back to the retracted position from the extended position after the protrusion has moved to the extended position.

8. The filtering apparatus of claim 7, wherein the additional housing portion includes a cylindrical shaft that extends through a cylindrical passage within the second cylindrical housing, wherein at least one lip seal is positioned in between the cylindrical passage and the cylindrical shaft to restrict fluid flow between the passage and shaft, wherein the shaft includes a recess at a location along a surface of the shaft, wherein the recess moves up to the lip seal in a first direction when the protrusion moves to the extended position, and wherein the lip seal prevents movement of the recess away from the lip seal in a second direction opposite the first direction after the recess has moved up to the lip seal in the first direction.

9. The filtering apparatus of claim 1, further including a temperature-sensitive component that prevents the protrusion from moving to the extended position from the retracted position when an operating temperature falls below a temperature threshold even when the second force exceeds the threshold.

10. The filtering apparatus of claim 9, wherein the additional housing portion includes a shaft that extends through a passage within the second cylindrical housing, wherein the shaft at least one of is coupled to and is formed integrally with the protrusion, and wherein the temperature-sensitive component includes a portion of wax within the passage between a wall of the passage and the shaft, wherein when the operating temperature falls below the temperature threshold, the wax expands to prevent movement of the shaft relative to the passage.

11. The filtering apparatus of claim 1, wherein the additional housing portion includes a piston and a flange portion extending outward from the piston, wherein at least portions of the external and internal surfaces of the additional housing portion are formed on the flange.

12. The filtering apparatus of claim 11, wherein the piston extends from a first end of the device to a second end of the device and further, at the second end of the device, through an orifice in the second cylindrical housing, and wherein the protrusion is a top portion of the piston.

13. The filtering apparatus of claim 12, wherein coupled to and extending within the first cylindrical housing is a support structure having a rim portion and a cylindrical portion, wherein the rim portion supports the tubular filter.

14. The filtering apparatus of claim 13, wherein the device extends within the cylindrical portion, wherein the first end of the device is supported at least indirectly by a first end of the cylindrical portion, and wherein the cylindrical portion extends at least partly into the inner region so that the device extends at least partly into the inner region.

15. The filtering apparatus of claim 14, wherein the first end of the cylindrical portion includes a first orifice, wherein the device includes an annular member that is supported by the first end of the cylindrical portion, wherein the piston extends through both the first orifice and a second orifice within the annular member so that the piston extends up to the inner region, and wherein an additional spring is positioned onto the second cylindrical housing and extends up to the annular member to provide pressure thereupon tending to move the annular member away from the second cylindrical housing so that the device is tightly positioned in between the second end of the first cylindrical housing and the first end of the cylindrical portion.

16. The filtering apparatus of claim 15, wherein a space exists between the flange portion and the annular member allowing at least some of the input fluid to proceed into the space so that the outer fluid pressure is applied against the flange portion, thus providing at least some of the second force.

17. The filtering apparatus of claim 1, wherein the input fluid is at least one of oil, a lubricant other than oil, a hydraulic fluid other than oil, water, and air.

18. A removable filtering apparatus for implementation in an engine, the apparatus comprising:
a housing having an inlet and an outlet and at least first and second cavities that are coupled to the inlet and the outlet, respectively, wherein an input fluid within the first cavity has an input fluid pressure and an output fluid within the second cavity has an output fluid pressure;
a filter supported within the housing, wherein at least a portion of the filter extends along an axis within the housing, and wherein the filter at least partly separates the first and second cavities from one another;
a device capable of determining whether the input fluid pressure exceeds the output fluid pressure by a predetermined amount and providing an indication thereof, wherein the device is supported by the housing and extends into the housing along the axis and at least partly into a void within the filter.

19. The filtering apparatus of claim 18, wherein each of the housing, the filter, the void and the device is substantially cylindrical.

20. The filtering apparatus of claim 18, wherein the filtering device further comprises at least one of:
means for locking an indicator in a first position as the indication that the input fluid pressure exceeds the output fluid pressure by the predetermined amount when the indicator enters the first state; and
means for preventing the indicator from entering the first position when a temperature of operation of the filtering apparatus falls below a threshold.

21. A method of operating a filtering device to provide an indication of when a filter within the filter device is excessively dirty, the method comprising:
providing a housing within which is supported a filter, wherein at least a portion of the filter extends along an axis within the housing, wherein the filter at least partly separates first and second cavities within the housing containing input fluid and filtered fluid, respectively, and wherein an input fluid pressure is experienced within the first cavity and a filtered fluid pressure is experienced within the second cavity;
providing a component capable of determining whether the input fluid pressure exceeds the filtered fluid pressure by a predetermined amount, wherein the component is supported by the housing and extends into the housing along the axis and at least partly alongside the filter;
operating the component to perform filtering;
experiencing a change in at least one of the input fluid pressure and the filtered fluid pressure that results in the input fluid pressure exceeding the filtered fluid pressure by at least the predetermined amount; and
providing an indication at the component that the input fluid pressure exceeds the filtered fluid pressure by at least the predetermined amount.
